(19) United States
(12) Patent Application Publication
(10) Pub. No.: US 2025/0022488 A1
(43) Pub. Date: Jan. 16, 2025

(54) System and Method for Merging and Editing Multiple Videos for Online Platforms

(71) Applicant: Aleksandr Zimin, Miami, FL (US)

(72) Inventor: Aleksandr Zimin, Miami, FL (US)

(73) Assignee: Aleksandr Zimin, Miami, FL (US)

(21) Appl. No.: 18/350,006

(22) Filed: Jul. 11, 2023

(51) Int. Cl. G11B 27/036; G06F 3/0484

(52) U.S. Cl. CPC G11B 27/036; G06F 3/0484

(57) ABSTRACT

The present invention discloses a video editing and merging system that allows users to combine multiple videos into a single, cohesive video while preserving the metadata associated with each individual video. The platform offers a user-friendly interface, enabling users to trim, cut, crop, and enhance the merged video. It also provides a preview feature for users to review and make adjustments before finalizing the video. The system seamlessly interacts with online platforms through APIs to retrieve video metadata, ensuring accurate and up-to-date information. By preserving metadata, including video attributes like views, comments, and likes, the merged video maintains its visibility and popularity. The platform empowers users to create compelling video content while maintaining the original context and relevance of each video.

### FIELD OF THE INVENTION

The present invention relates to the field of multimedia content management, and more specifically, to a method and system for combining multiple videos into a single video for online platforms such as YouTube. The invention enables the merging of videos while preserving comments and views, as well as providing editing capabilities for trimming, cutting, and modifying the merged video.

### BACKGROUND OF THE INVENTION

With the proliferation of online video sharing platforms, such as YouTube, there is a growing need for users to merge multiple videos into a single coherent video. However, existing methods often require downloading and re-uploading videos, resulting in loss of views, comments, and the inconvenience of managing multiple video files. There is a need for a more convenient and efficient method that allows users to merge and edit videos seamlessly while preserving the associated metadata and video attributes.

The US application U.S. Pat. No. 8,555,169B2 titled ‘Media clip auditioning used to evaluate uncommitted media content’ discloses a media-editing application for creating media clip presentations. The media-editing application consists of a graphical user interface (GUI). The GUI comprises a display area for displaying a presentation created by adding a plurality of video clips. In addition, the user can add different video clips into one single video. Moreover, the GUI includes a timeline with various media clips that can delete or trim the clips before the final presentation. Furthermore, the GUI works in four stages by adding, deleting, or replacing the video clips from the timeline to get the final presentation.

The WO application WO2023284316A1 titled ‘Video editing method and apparatus, and electronic device and readable storage medium’ discloses a video editing method and apparatus. The video editing method comprises a video to be edited or determines the target frame in the video be edited. The video editing method supports editing by extracting an initial video from the target frame according to the image and audio data in the initial video. Meanwhile, the method determines a start frame and an end frame of the initial video. After that, the user can merge multiple video clips in the initial video to convert the videos into one single video. Further, the video editing method also supports trimming or cutting the clip from the video by using the target frame.

The non-patent literature Flixier is a free online video editor application. The Flixier application comprises a method to create and publish videos on YouTube or other platforms. The Flixier application allows merging videos from different platforms into one single video. Moreover, the user can copy the URL of multiple YouTube videos and simply paste it into the Flixier application to merge or edit videos. Further, the Flixier application supports trimming or cutting video clips in just a few clicks. Hence users can directly publish the edited video from the Flixier application to YouTube or other platforms.

The non-patent literature Veed.io is a free online YouTube video combiner. The veed.io works online to combine, merge and trim YouTube videos effortlessly. The Veed.io allows the user to upload two or more videos to the editor to edit the videos before merging them into one single video. Moreover, the user can rearrange the video clips on the timeline with simple drag-and-drop options. The Veed.io also provides features to adjust the length of the video, add subtitles, and transition the video. Hence users can trim, cut or crop the unnecessary part of the video before exporting the merged YouTube video.

### SUMMARY OF THE INVENTION

The present invention provides a novel method and system for merging multiple videos into a single video on online platforms, such as YouTube, while preserving the associated comments and views. The invention further enables users to edit, trim, cut, and modify the merged video, enhancing the overall user experience. By combining these features, the invention revolutionizes the process of merging and editing videos on online platforms, offering users greater convenience and flexibility.

The System and Method for Merging and Editing Multiple Videos is a video editing and merging system that enables users to seamlessly combine multiple videos into a single cohesive composition. The system offers a range of innovative features and functionalities to enhance the editing and merging process, ensuring a high-quality final output.

Through its retrieval module, the system allows users to collect video data from various online platforms by using video links. This module interacts with the platforms' APIs to retrieve the necessary metadata, including unique identifiers, titles, descriptions, and video attributes such as views, comments, and likes. This ensures that the system can access the relevant video content and associated metrics required for merging and editing.

The system provides a user-friendly interface that empowers users to edit and customize the merged video. Users have the ability to trim, cut, crop, and modify the video to remove unwanted sections, adjust duration, or enhance visual appeal. Additionally, users can select and choose which metadata to display in the final render, allowing for a tailored and personalized viewing experience.

During the final rendering of the video, the system strategically integrates the metadata into the visual presentation. The system allows users to incorporate the metadata within the video itself, such as overlays, or lower thirds. This integration ensures that the video attributes, including likes and comments, are seamlessly embedded within the merged video, creating a cohesive and visually appealing viewing experience.

Furthermore, the system offers customization options for the visual representation of the metadata. Users can select various visual styles, fonts, colors, and sizes to match the overall aesthetic of the video. This flexibility allows users to create visually appealing compositions where the metadata blends seamlessly with the content, enhancing the overall professionalism and visual appeal of the final render.

The System and Method for Merging and Editing Multiple Videos on Online Platforms provides users with a powerful toolset to create high-quality merged videos. By leveraging advanced retrieval, editing, and rendering capabilities, the system enables users to combine videos from different sources, customize the appearance of metadata, and deliver a visually compelling final product that seamlessly incorporates video attributes.

### BRIEF DESCRIPTION OF THE DRAWINGS

Reference will now be made to the accompanying drawings, which are not necessarily drawn to scale, and wherein:

FIG. 1 is an illustration of an exemplary, non-limiting embodiment of a System and Method for Merging and Editing Multiple Videos in accordance with various aspects described herein.

FIG. 2 is an illustration disclosing the user end of the Merging and Editing Multiple Videos on Online Platforms.

FIG. 3 is an illustration disclosing the video merging module.

FIG. 4 is an illustration disclosing the working video merging module.

FIG. 5-6 are the illustrations disclosing the video editing module.

FIG. 7 is the illustration disclosing the preview module.

FIG. 8 is the illustration disclosing the metadata display module.

FIG. 9 is the illustration disclosing the final render of the video display module.

### DESCRIPTION OF THE INVENTION

Provided below is the non-limiting exemplary embodiment of the present disclosure and a reference will now be made in detail to specific embodiment or features, examples of which are illustrated in accompanying drawings. Wherever possible, corresponding or similar references numbers will be used throughout the drawings to refer to the same or corresponding parts. Moreover, reference of the various elements described herein, are made collectively or individually when there may be more than one element of the same type. However, such references are merely exemplary in nature. It may be noted that any reference to element in the singular may also be constructed to relate to the plural and vice-versa without limiting the scope of the disclosure to the exact number or type of such element unless set forth explicitly in the appended claim.

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

The invention presents a novel platform system that addresses the aforementioned requirements by facilitating a collaborative video editing creation, production, and distribution process. The platform has the potential to democratize digital video processes, empowering a new generation of artists, writers, content creators, and market participants. By significantly increasing the number of professional and amateur video creators and industry players, this platform contributes to the overall digital content and economy of the video industry. This unique production environment enables virtually anyone who desires to create video content. Moreover, the script can incorporate placeholders, command lines, and producer/editor comments, enabling the automatic uploading of videos captured by socially connected users into pre-assigned slots in the video editor timeline. This feature facilitates collaborative storytelling and transforms video production into a social experience. Users can access this platform through the app version on their mobile devices. The platform fosters collective efforts and collaboration, in contrast to the current fragmented individual endeavors or expensive and inflexible production studio models, thereby creating collective value. The “Community-Driven” web application also serves as a meeting point for amateurs, professionals, and celebrities, where amateur users may receive feedback or have the opportunity for cameo appearances by celebrities and professionals, serving as the ultimate reward.

The method and system disclosed herein enable the merging and editing of multiple videos into a single video from online platforms.

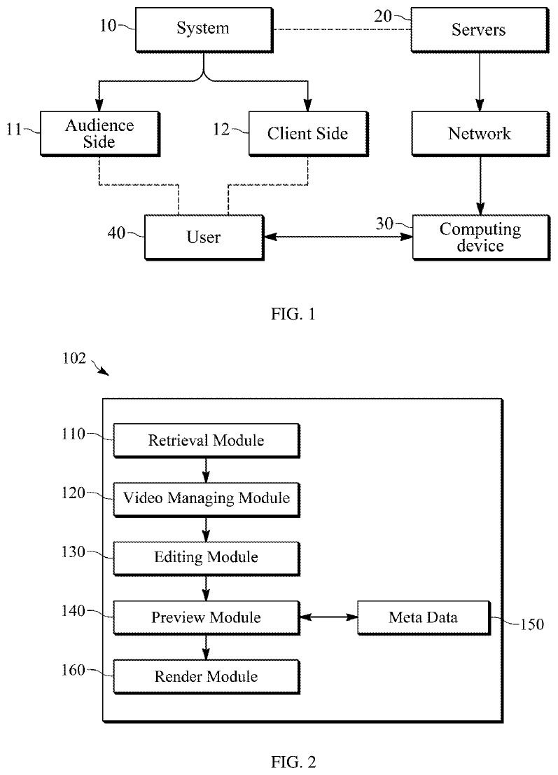

Referring to FIG. 1, a system 10 for editing and merging videos online is shown. The system 10 operates as a centralized platform for video editing and merging, with its functionality operated by a plurality of servers 20. The servers 20 form the backend infrastructure, working in tandem to provide the necessary computational power, storage, and data processing capabilities.

A user 40 can accesses the system 10 using a computing device 30, such as may include one or more of a cellular telephone, a smartphone, a digital camera, a laptop, a tablet computer, a desktop computer, a television set-top box, smart TV, a gaming console, a client computing platform, and/or other platforms.

The system 10 comprises two main components: an audience side, labelled as Audience Side 11, and a client side, known as Client Side 12.

The audience side 11 refers to the part of the system 10 that is responsible for handling the display and distribution of the edited and merged videos. It serves as the interface through which the final videos are presented to the intended viewers or audience.

The client side 12 represents the part of the system 10 that is responsible for user 40 interactions and operations. This includes the functionalities related to video editing and merging, allowing the user 40 to edit and combine video files according to their preferences.

Both the audience side 11 and client side 12 can be accessed by the user 40. Through this access, the user 40 can perform video editing and merging tasks.

The client-side 12 interface allows the user 40 to interact with the features of system 10. The client-side 12 communicates with the servers 20 through network connectivity, establishing a connection to the backend.

Referring to FIG. 2, the working process of system 10 for merging and editing multiple videos into a single video online will be explained. The system 10 comprises a retrieval module 110, a video merging module 120 and editing module 130, a preview module 140, a metadata display module 150, and a rendering module 160. The various modules will be discussed in greater details in the disclosure.

Referring to FIG. 3, the retrieval module 110 is explained. The retrieval module 110 serves the purpose of gathering video data from various sources. It consists of a system interface 111 with multiple tabs 112, allowing users to insert and organize links related to different videos they wish to retrieve. The tabs 112 help users categorize and manage their video retrieval activities effectively. The retrieval module 110 further comprises display icons 113 that provide a visual representation of the retrieved videos. These icons serve as visual cues for users, displaying the videos that have been retrieved from the links inserted in the tabs 112. The display icons 113 can be designed in different ways, such as thumbnail images or graphical representations, to visually distinguish each video.

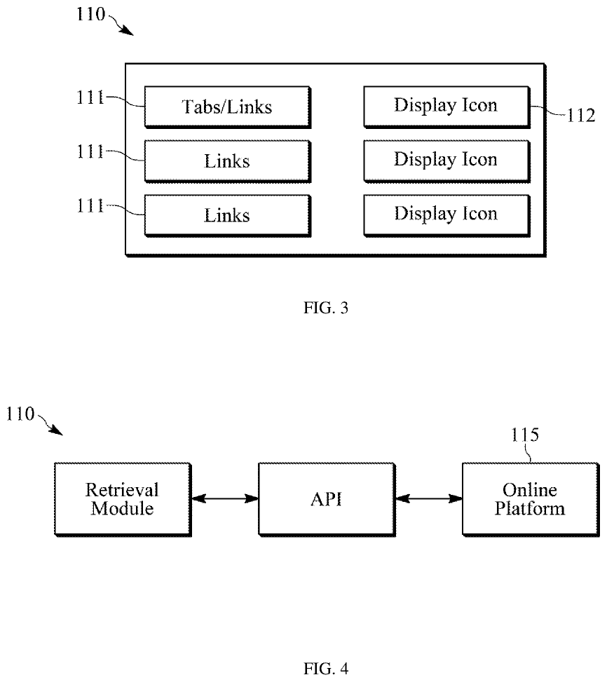

As shown in FIG. 4, the retrieval module 110 interfaces with the external platform 115 (e.g., YouTube) using an Application Programming Interface (API) to retrieve the videos to be merged. An API is a set of protocols and tools that allows different software applications to communicate with each other.

By utilizing the API, the retrieval module 110 gains access to the video metadata stored on the online platform 115. This metadata includes various information about the videos, such as their unique identifiers, titles, descriptions, and video attributes. The unique identifiers help distinguish one video from another and ensure accuracy during the merging process.

Furthermore, the API provides the retrieval module 110 with access to the video attributes associated with each video, which comprise the number of views, comments, and likes. These metrics serve as indicators of a video's popularity, user interaction, and engagement level. By accessing and utilizing these video attributes, the system can make informed decisions and incorporate the relevant metadata into the merged and edited videos, enhancing their overall quality and appeal.

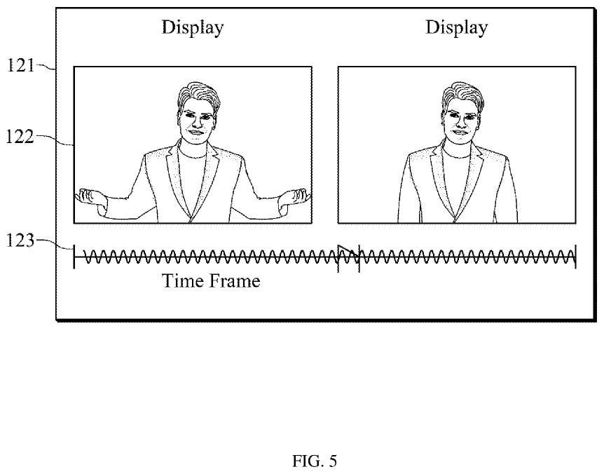

Referring now to FIG. 5, the video merging module 120 will be explained. Video merging module 120 is responsible for the placements of videos and incorporates an interface 121 to facilitate the process. The interface 121 comprises two key components: the video display region 122 and the time frame display region 123, positioned below the video display region 122

The video display region 122 serves as the primary area where the various videos, retrieved from the retrieval module 110, are presented in a sequential manner. User can view the videos within this region to assess their content and determine their desired arrangement in the merged video. To modify the sequence of the videos, a convenient pick and drop option is provided, allowing users to easily rearrange the order of the videos by selecting and dragging them to their desired positions within the display region 122

The time frame displays 123 offers a visual representation of the duration or time frame for each video. This display provides users with a clear understanding of the temporal distribution of the videos within the merged composition. By observing the time frames, users can effectively manage the overall duration and timing of the merged video, ensuring a smooth and cohesive viewing experience for the audience.

The video display region 122 and the time frame display 123 provide users with a comprehensive interface to visualize and manipulate the arrangement and timing of the retrieved videos.

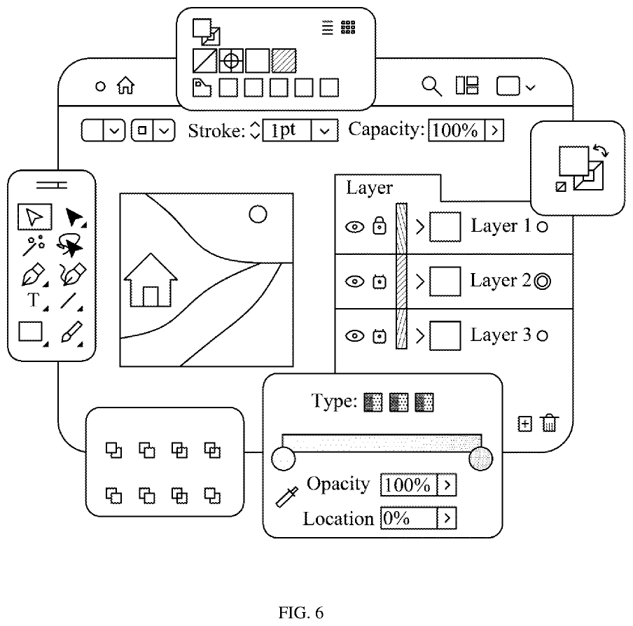

Referring to FIG. 6, the editing module 130 will be described in greater details. The editing module 130 provides the functionality of the trimming and selecting only a specific part of the videos available in the merging module 120. The editing module 130 provides users a comprehensive set of editing capabilities specifically designed for the merged video such as trimming, cutting, cropping, duration adjustment, visual enhancement etc.

Trimming: Users can trim the merged video by selecting specific start and end points. This allows them to remove unwanted sections from the video, such as introductory or concluding segments that may not be relevant to the merged content. Trimming ensures that the final video focuses on the essential content and eliminates any unnecessary or repetitive portions.

Cutting: The cutting feature enables users to divide the merged video into multiple segments. By identifying specific breakpoints within the video, users can create separate clips or extract specific parts for further editing or independent use. Cutting provides flexibility in manipulating the content by allowing users to isolate and rearrange video segments according to their preferences.

Cropping: With the cropping functionality, users can adjust the frame size and composition of the merged video. Cropping allows for the removal of unwanted areas or aspects of the video, resulting in a refined and visually appealing presentation. Users can select a desired aspect ratio or customize the cropping area to emphasize specific content or achieve a specific visual effect.

Duration Adjustment: The system permits users to modify the duration of the merged video. Users can extend or shorten the video's overall length to fit specific requirements or desired playback durations. This flexibility enables users to adapt the merged video for various platforms, such as social media, where specific time constraints may exist.

Visual Enhancement: The editing capabilities include features to enhance the visual appeal of the merged video. Users can adjust various visual parameters, such as brightness, contrast, saturation, and color grading, to optimize the overall visual quality and ensure consistency across the merged content. These enhancements help create a polished and professional appearance for the final video.

The user-friendly interface 131 of the editing module 130 simplifies the editing process, making it accessible and intuitive for users. Using the interface 131, users can interactively manipulate the merged video, previewing the changes in real-time and fine-tuning the editing adjustments to achieve the desired outcome. The interface 131 may include a timeline representation of the video, with controls and options for editing functionalities conveniently accessible to users.

The video merging module 120 and the video editing module 130 together provides a processes to edit retrieved videos and merges them into a single video file. The merging process involves concatenating the video streams, ensuring smooth transitions between videos, and synchronizing the audio tracks to maintain continuity. Various algorithms and techniques known in the art can be employed to achieve seamless video merging.

Once the videos are retrieved, the system initiates the merging process by combining them into a single video file. This process can be selected from the below mentioned several steps to ensure a seamless merging experience.

### Concatenating Video Streams:

The process of concatenating video streams involves combining the individual video streams from the retrieved videos and arranging them in a specific sequence. The system ensures that the videos are aligned in a sequential manner, one after the other, to create a cohesive merged video. To achieve this, the system takes each video stream and connects it to the next video stream in the desired order. By joining the video streams together, the system eliminates any gaps or interruptions between the videos, ensuring a smooth and uninterrupted playback experience for the viewers. During the concatenation process, the system takes into account the duration of each video and ensures that the subsequent video starts playing immediately after the previous one ends. This seamless transition from one video to another allows the merged video to play continuously, without any noticeable pauses or disruptions. By concatenating the video streams in a sequential manner, the system creates a unified and cohesive playback experience. Viewers can watch the merged video as if it were a single video, seamlessly flowing from one segment to the next. This ensures that the final merged video appears as a coherent composition, where the individual videos seamlessly blend together to form a cohesive narrative or presentation.

### Smooth Transitions

To maintain a seamless transition between the merged videos, the system implements various techniques aimed at smoothing the visual shift from one video to another. These techniques include popular methods such as crossfading, fade-in, fade-out, and other transition effects that facilitate a continuous flow between video segments. Crossfading is a commonly used technique where the system gradually fades out the ending of one video while simultaneously fading in the beginning of the next video. This gradual blending creates a smooth transition and ensures a seamless connection between the videos. The duration of the crossfade can be adjusted to control the speed and intensity of the transition. Furthermore, the system may utilize fade-in and fade-out effects at the start and end of each video segment. A fade-in effect gradually increases the visibility of a video, while a fade-out effect gradually decreases its visibility. By employing these effects, the system achieves a gradual and visually appealing transition between the videos. In addition to these techniques, other transition effects like wipes, dissolves, or slides may also be applied, depending on the desired visual style and the content of the videos. These effects add creativity and variety to the transition process, enhancing the overall smoothness and coherence between the merged video segments. These techniques ensure that viewers experience a visually seamless and uninterrupted transition from one video to the next. By minimizing any sudden changes or disruptions, the system enhances the overall viewing experience and maintains viewer engagement throughout the merged video composition.

### Synchronization of Audio Tracks

In order to maintain audio continuity, the system synchronizes the audio tracks of the videos during the merging process. This synchronization ensures that the audio transitions between the videos are seamless and aligned with the visual transitions, resulting in a coherent and uninterrupted audio experience throughout the merged video. During the synchronization process, the system analyzes the audio tracks of each video and adjusts their timing to ensure they are in sync with one another. This synchronization is crucial to avoid any jarring or abrupt audio shifts that may disrupt the viewing experience. By aligning the audio tracks, the system ensures that background music, sound effects, dialogue, or any other audio elements smoothly transition from one video segment to the next. The system achieves audio synchronization by employing various techniques, such as adjusting the playback speed, manipulating the audio waveforms, or applying time-stretching algorithms. These techniques help to align the audio tracks and maintain their coherence throughout the merged video. Additionally, the system may also consider factors like volume levels and audio equalization to ensure a consistent audio experience across all the videos. It may adjust the volume levels of the audio tracks to create a balanced and seamless audio transition. Moreover, equalization techniques can be applied to match the audio characteristics of the videos, ensuring a harmonious blend of sound throughout the merged video. By synchronizing the audio tracks, the system enhances the overall viewing experience by providing a seamless and immersive audiovisual presentation. The synchronized audio ensures that the viewer perceives the merged video as a unified composition with a coherent and uninterrupted audio narrative.

### Seamless Video Merging Techniques:

To achieve a high-quality and seamless merging outcome, the system incorporates a range of algorithms and techniques that are well-established in the field of video editing and merging. These techniques are carefully selected to minimize visual artifacts and ensure the overall video quality is maintained throughout the merging process. One of the techniques utilized by the system is frame interpolation, which involves generating additional frames between the original frames of the videos. This interpolation helps to smoothen the motion and create a more fluid visual transition between the merged videos. By inserting these intermediate frames, the system enhances the overall visual cohesiveness and reduces any jarring effects that may arise from abrupt scene changes. Another technique employed is motion estimation, which involves analyzing the motion within the video frames. By tracking the movement of objects and subjects in the videos, the system can accurately align and merge the videos based on their motion patterns. This technique ensures that the merged video maintains a consistent flow of movement, contributing to a seamless viewing experience. Temporal alignment is another critical technique used by the system. It involves precisely synchronizing the timing and duration of video segments to eliminate any temporal discrepancies or mismatches. By aligning the temporal aspects of the videos, such as the timing of events or transitions, the system ensures a seamless progression and continuity in the merged video. In addition to these techniques, the system may employ other methods specific to minimizing visual artifacts, such as color correction, exposure adjustment, or noise reduction. These methods aim to enhance the overall video quality by addressing any imperfections or inconsistencies that may arise during the merging process. By leveraging these algorithms and techniques, the system strives to deliver a high-quality merging outcome that maintains the original video content's integrity while achieving a seamless and visually pleasing result. The application of these techniques helps to minimize any visual distortions or disruptions, ensuring that the merged video appears as a cohesive composition with minimal artifacts.

By employing these merging techniques, the system ensures that the resulting merged video appears as a single, cohesive piece without any abrupt changes or disruptions. The aim is to create a seamless viewing experience for users, where the merged videos flow naturally and maintain the original video content's integrity.

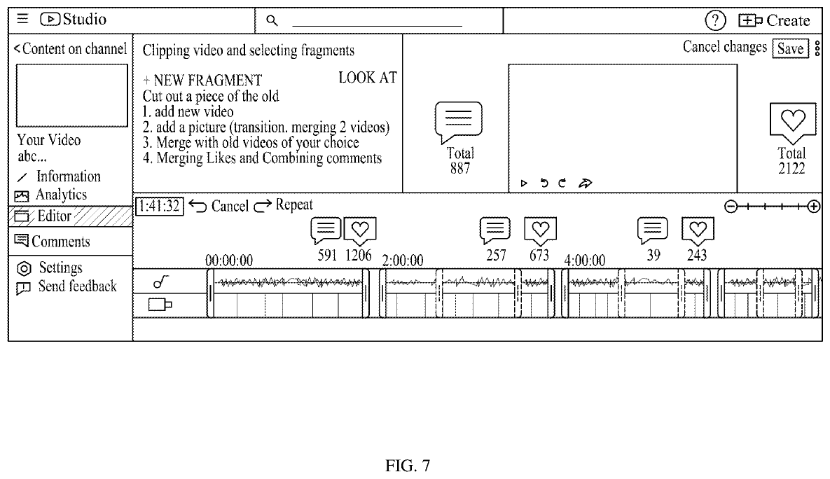

Referring now to FIG. 7, the preview module 140 will be explained. The preview module 140 enables users to evaluate the merged and edited video before finalizing it. User have the ability to play the video within the system interface, allowing them to review the modifications and make any necessary adjustments. The purpose of the preview function is to provide users with a visual representation of the final output, allowing them to assess the quality and coherence of the video.

By utilizing the preview module 140, user can observe the merged and edited video in real-time. This allows them to gain a comprehensive understanding of how the different video segments have been merged together and how any editing actions, such as trimming, cutting, or cropping, have influenced the overall presentation. Users can assess the flow and smoothness of the merged segments, ensuring that the transitions are seamless and the pacing is appropriate.

During the preview, users have the opportunity to review the modifications made to the video and make any necessary adjustments based on their observations. For instance, if they identify sections that require further trimming or if the transitions between segments need refinement, they can make the necessary changes before finalizing the video.

The preview module is user-friendliness, providing intuitive navigation through the video. Users can access playback controls, such as play, pause, rewind, or fast-forward, to analyze specific portions or sequences in detail. This enables them to have a comprehensive view of the video and make informed decisions about the necessary adjustments.

The preview module 140 ensures that users have the ability to thoroughly evaluate and fine-tune the merged and edited video. It serves as a valuable tool for quality control, allowing user to assess the video's coherence and make necessary refinements to achieve the desired outcome.

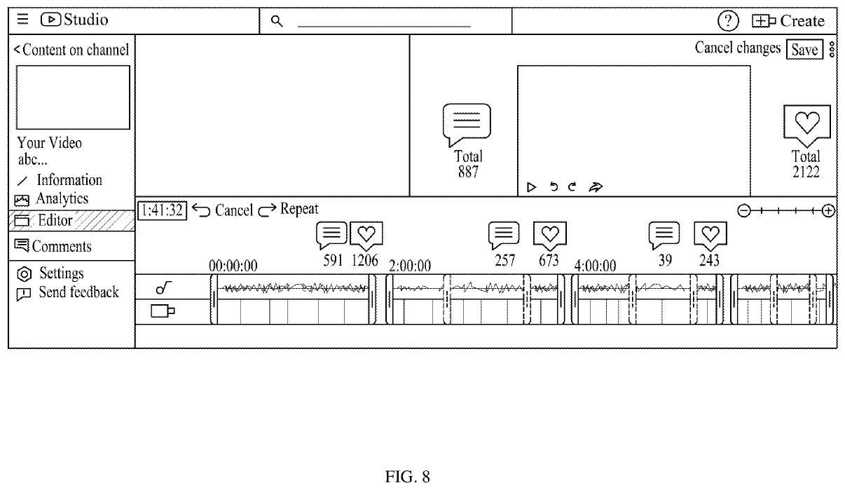

Referring to FIG. 8, the metadata display module 150 is explained in greater details.

The retrieval of metadata from various video links typically involves the system 100 interaction with the Application Programming Interface (API) provided by other online platform, such as YouTube. This API serves as a communication channel between the system and the platform's servers, enabling the system to request and obtain metadata for the specified videos.

When a user provides multiple video links to the retrieval module 110, the system 10 utilizes the API to make separate requests for each video. These requests are structured to include the unique identifiers or URLs of the videos, along with specifications for the desired metadata fields such as title, description, tags, and video attributes.

Upon receiving these API requests, the platform's servers 103 process the requests and respond with the corresponding metadata for each video. The system 10 then parses the response data, and extracts the relevant metadata information needed for the merging process.

By leveraging the external platform's API, the system 10 gains authorized access to the video metadata stored on the external platform's servers. This ensures that the retrieved metadata is accurate and reflects the most up-to-date information available for each video.

The system 10 ability to retrieve metadata depends on the public accessibility and availability of the video metadata through the external platform's API. If certain metadata is not publicly accessible or if the external platform restricts access to specific information through its API, the system 10 may encounter limitations in retrieving that particular metadata for the merging process.

During the merging process, the system 10 ensures that the metadata related to each video being merged is retained. This metadata includes various information such as comments, views, likes, and other video attributes associated with the original videos.

To maintain the contextual relevance of the comments within the merged video, the system 10 arranges the comments in a chronological order or according to the user's preferences. This ensures that the comments appear in the merged video in the same order as they appeared in the original videos, allowing viewers to understand the flow of the conversation and maintain the context of the comments.

By preserving the comments and their arrangement, the system 10 ensures that the merged video reflects the engagement and discussions from the original videos, enhancing the viewing experience for users and maintaining the integrity of the content.

The system 10 arranges the comments in the merged video in a chronological order. This ensures that the comments appear in the merged video in the same sequence as they appeared in the original videos. By maintaining the chronological order, the system allows viewers to follow the flow of the conversation and understand the context of each comment.

The system 10 also takes into account the context of comments within the merged video. It analyzes the content of the comments, their replies, and the video segments to which they refer. By considering the context, the system ensures that the comments are presented in a way that aligns with the video content and maintains their relevance within the merged video.

The system 10 provides users with options to customize the arrangement and display of comments based on their preferences. Users can choose to arrange comments by popularity, user engagement, or other criteria. This customization feature enhances the user experience by allowing viewers to prioritize the comments they find most relevant or interesting.

Along with comments, the system 10 aggregates other video attributes such as views, likes, and dislikes from the original videos. These metrics are combined and updated to reflect the total engagement received by the merged video. By preserving and aggregating these metrics, the system accurately represents the popularity and reception of the merged video.

The system 10 incorporates an intuitive user interface that displays the preserved metadata alongside the merged video. Users can access and view the comments, video attributes, and other relevant metadata in a cohesive manner. This feature allows viewers to interact with and contribute to the ongoing discussions surrounding the merged video.

In the process of displaying metadata in the final video, the system 10 also has the capability to show specific video attributes at designated timeframes. These video attributes provide information about the viewer's engagement with the content, such as the number of likes, comments, shares, views, or any other relevant measures of interaction.

To enhance visual accessibility, the system can display these video attributes as overlays or captions at specific moments within the video. This allows viewers to see the attribute data in real-time or as they watch the video.

Additionally, the system 10 analyses the video attribute data to determine the time frame in which the maximum engagement occurs. It identifies the specific moment or segment of the video where viewers are most actively interacting with the content. This peak engagement period can be visually highlighted or emphasized, using graphical representations or visual cues, to draw attention to the most engaging parts of the video.

By providing these video attributes and highlighting the maximum engagement timeframe, the system 10 offers valuable insights to content creators or analysts. They can gain an understanding of which parts of the video generated the most interest and engagement from viewers, informing their content creation strategies and improving future video content.

In the video editing and merging system 10, users are provided with a range of options to select and customize the display of metadata in the final rendered video. The system 10 offers a user-friendly interface that allows users to precisely choose which metadata elements to include and showcase in the merged video. This selection process enables users to curate the viewer interactions and video attributes that are most relevant to their desired video output.

Within the system 10 editing environment, users can access a dedicated settings panel or menu, where they can toggle various options related to the display of metadata. They have the flexibility to include or exclude specific video attributes such as likes, comments, views, or other pertinent information associated with the individual videos being merged. This level of customization empowers users to highlight the aspects of viewer interaction that align with their creative intentions or the message they wish to convey through their video.

Furthermore, the system 10 provides users with the ability to control the presentation style of the selected metadata. They can choose from a variety of visual formats, including overlaying the metadata as text or graphics on the video, displaying it in a separate section of the screen, or incorporating it into the video's transitions or animations. These options allow users to enhance the visual appeal and overall cohesiveness of the merged video while effectively communicating the desired video attributes.

The feature that allows selective display of metadata in the final render not only provides users with a high degree of customization but also enhances the storytelling and narrative capabilities of the system 10. Users can strategically utilize the displayed video attributes to create a more engaging and immersive viewing experience, showcasing the popularity and interaction surrounding their merged video content.

The video editing and merging system 10 offers users extensive control over the inclusion and presentation of metadata in the final rendered video. This level of customization ensures that the merged video accurately represents the desired video attributes and allows users to effectively convey their creative vision.

In this embodiment, users can not only select which metadata to include but also have fine-grained control over how the metadata is presented and interacted with in the merged video.

One aspect of this embodiment is the ability to customize the visual appearance of the metadata. Users can select from various styles, fonts, colors, and sizes to match the overall aesthetics of their video or to highlight specific video attributes. Furthermore, users can choose the placement and positioning of the metadata within the video frame, ensuring optimal visibility and minimal interference with the content.

In addition to visual customization, this embodiment also offers interactive features for the displayed metadata. Users can define how viewers can interact with the metadata elements while watching the merged video. For example, users can enable clickable links within the metadata, allowing viewers to directly access related content or external websites. Users can also incorporate interactive buttons or icons that trigger specific actions, such as displaying additional information or prompting viewers to leave comments or likes.

The system allows users to define the timing and duration of metadata display. Users can specify when and for how long the video attributes should be visible in the merged video. They can synchronize the appearance of the metadata with specific video segments or transitions to enhance the storytelling or highlight important moments.

When it comes to the final render video, the system 10 allows users to strategically integrate the metadata into the visual presentation. Users can incorporate the metadata within the video itself. This integration ensures that the video attributes are seamlessly embedded within the merged video, creating a cohesive viewing experience. By visually representing the metadata within the final render, users can effectively communicate the collective popularity and viewer interaction associated with the merged video composition.

Additionally, the system 10 offers customization options for the visual appearance of the metadata. Users can select various visual styles, fonts, colors, and sizes to match the overall aesthetic of the video. This flexibility allows users to create visually appealing and harmonious compositions where the metadata blends seamlessly with the content. By aligning the visual representation of the metadata with the overall look and feel of the video, users can enhance the visual appeal and professionalism of the final render.

The user is provided with the feature to selectively delete or hide specific metadata from the final video. This means that, during the editing process, the user has control over which metadata information is included in the video and which is removed or kept hidden.

The system allows the user to delete unwanted metadata entirely, ensuring that it does not appear in the final version of the video. This deletion process eliminates any undesired information from being displayed to viewers.

Alternatively, the user can choose to hide certain metadata from being visible to viewers while still retaining it within the video. This hiding functionality enables the user to keep specific metadata information accessible for their own reference or analysis but ensures that it remains unseen by the audience.

By offering these options to delete or hide selective metadata, the system provides flexibility and customization to the user. They can tailor the metadata presentation in the final video according to their preferences, ensuring that only the desired information is visible to viewers.

By providing advanced options for managing and controlling the display of metadata, the system 10 enables users to create highly customized and interactive merged videos. It empowers users to effectively communicate the desired video attributes while maintaining creative control over the visual presentation and viewer interaction. This embodiment enhances the overall viewing experience and allows users to curate engaging and compelling video content that resonates with their intended audience.

Referring again to FIG. 7 and FIG. 8, during the preview stage, the full video has the capability to showcase video attributes at various segments of the time frame across multiple videos. This functionality allows viewers to observe and analyze the video attributes associated with specific portions or segments of each video included in the compilation.

As the full video plays, the system dynamically presents the relevant video attributes at different points in time, synchronized with the corresponding segments from each video. This synchronized display enables viewers to comprehensively understand the distribution of video attributes throughout the multiple videos being previewed.

By presenting the video attributes in this manner, the system empowers users to assess engagement levels, viewer reactions, or other pertinent video attributes for each segment within the compilation. This feature provides valuable insights into the overall performance and viewer engagement across the entire full video, offering users a comprehensive perspective on the video attributes within the various time segments.

### Finalization and Upload

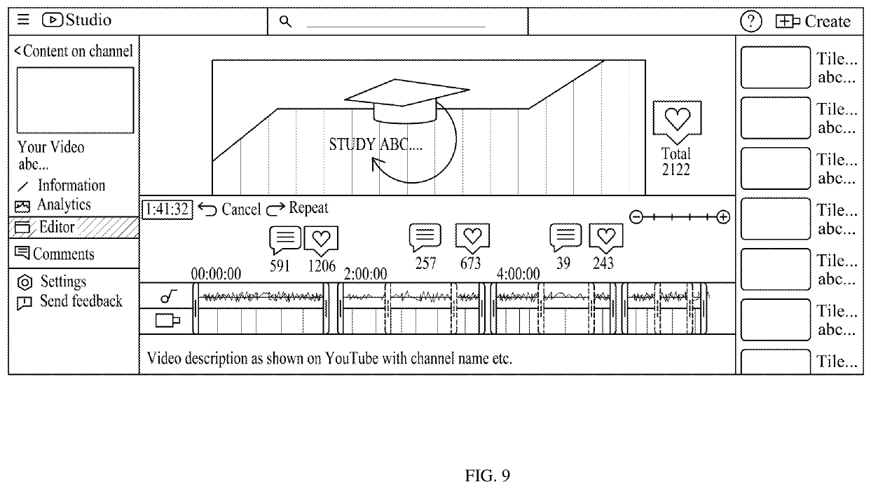

Referring to FIG. 9 once users are satisfied with the merged and edited video, they have the option to finalize it and select the upload option to send it back to the online system 10. The system interacts with the platform's Application Programming Interface (API) to facilitate the upload process, ensuring a seamless and efficient transfer of the video.

Then users initiate the upload, the system 10 establishes a connection with the platform's API, enabling communication and data exchange with the platform's servers. This secure interaction allows the system 10 to transmit the merged video to the online platform.

Throughout the upload process, the system 10 ensures that the merged video retains its connection to the original video's metadata, including the title, description, tags, and video attributes such as views, likes, and comments. By preserving this metadata, the system 10 ensures a seamless integration of the merged video within the existing content on the online platform.

By associating the merged video with the original metadata, the system 10 maintains the video's context and relevance within the online platform's ecosystem. This integration enables users to leverage the visibility and popularity of the original video, contributing to the merged video's visibility and potential engagement.

The system 10 employs secure transmission and storage measures to protect the video's content during the upload process. This may involve encryption protocols and other security mechanisms to safeguard the video and prevent unauthorized access.

Once the upload process is successfully completed, the merged video becomes part of the online system 10 content library. It inherits the visibility and video attributes of the original video, providing users with the opportunity to reach a wider audience and benefit from the platform's existing user base.

During the final upload of the video, the video editing and merging system 10 offers a comprehensive display of metadata, ensuring that both the individual video metrics and the overall video attributes are effectively communicated to viewers.

Overall, the system 10 interaction with the external platform's API and its seamless transfer of the merged video, along with its associated metadata, ensure a smooth integration of the video into the online platform. By preserving the video's visibility and popularity, the system maximizes its impact and allows users to showcase their creative work within the system 10 ecosystem.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

1. A system for video editing and merging, the system comprises:
a) a retrieval module, for retrieving multiple videos from online platforms;
b) a merging module to combine the retrieved videos into a single video file while preserving metadata associated with each video, including unique identifiers, titles, descriptions, and video attributes, with specific emphasis on securing and preserving the likes, views and comments of the individual videos;
c) an editing module allowing users to edit the merged video;
d) a preview function enabling users to review and make adjustments to the merged and edited video;
e) an upload module to seamlessly upload the finalized video back to the online platform while associating it with the original video's metadata, ensuring the preserved videos attributes are accurately attributed to the merged video.

2. The video editing and merging system of claim 1, wherein the merging module techniques to ensure smooth transitions between video streams and synchronization of audio.

3. The video editing and merging system of claim 1, wherein the editing module provides interactive tools for users to trim, cut, crop, and enhance the merged video, enabling the removal of unwanted sections, adjustment of duration, and improvement of visual appeal.

4. The video editing and merging system of claim 1, wherein the preview function allows users to play and review the merged and edited video, facilitating adjustments to ensure quality and coherence.

5. The video editing and merging system of claim 1, wherein the upload module interacts with online platforms to seamlessly upload the finalized video while associating it with the original video's metadata, ensuring visibility and popularity of the merged video.

6. The video editing and merging system of claim 1, wherein the video attributes comprises details such as likes, views, comments and shares.

7. The video editing and merging system of claim 1, wherein system further comprises the feature of the selective deletion or hiding of metadata from the final video.

8. The video editing and merging system of claim 1, wherein system further comprises the feature for audio replacement feature, wherein the system allows users to select and replace the original audio track of the final video with an alternative audio track of their choice.

9. A method for merging multiple videos into a single video using a video editing and merging system, comprising the steps of:
a) retrieving multiple videos from online platforms using a retrieval module;
b) merging the retrieved videos into a single video file while preserving metadata associated with each video, including unique identifiers, titles, descriptions, and video attributes, with specific emphasis on securing and preserving the likes and comments of the individual videos using a merging module;
c) allowing users to edit the merged video using an editing module;
d) providing a preview function for users to review and make adjustments to the merged and edited video using a preview module;
e) uploading the finalized video back to the online platform while associating it with the original video's metadata, ensuring the preserved video attributes are accurately attributed to the merged video.

10. The video editing and merging system of claim 6, wherein the merging module techniques to ensure smooth transitions between video streams and synchronization of audio tracks.

11. The video editing and merging system of claim 7, wherein the editing module provides interactive tools for users to trim, cut, crop, and enhance the merged video, enabling the removal of unwanted sections, adjustment of duration, and improvement of visual appeal.

12. The video editing and merging system of claim 8, wherein the preview function allows users to play and review the merged and edited video, facilitating adjustments to ensure quality and coherence.

13. The video editing and merging system of claim 9, wherein the upload module interacts with online platforms to seamlessly upload the finalized video while associating it with the original video's metadata, ensuring visibility and popularity of the merged video.

14. The video editing and merging system of claim 9, wherein the video attributes comprises details such as likes, views, comments and shares.

15. The video editing and merging system of claim 9, wherein system further comprises the feature of the selective deletion or hiding of metadata from the final video.

16. The video editing and merging system of claim 9, wherein system further comprises the feature for audio replacement feature, wherein the system allows users to select and replace the original audio track of the final video with an alternative audio track of their choice.
